(19) United States
(12) Patent Application Publication
(10) Pub. No.: US 2006/0169556 A1
(43) Pub. Date: Aug. 3, 2006

(54) Shock absorber having a pressure gauge

(76) Inventor: Jung-yu Hsu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/046,832

(22) Filed: Feb. 1, 2005

(51) Int. Cl. F16F 9/00

(52) U.S. Cl. 188/314

(57) ABSTRACT

A shock absorber having a pressure gauge includes a main body and a pressure gauge. The pressure gauge is mounted on the top of a pressure chamber and interconnected with the pressure chamber. The pressure chamber is provided with an air inlet to pump air into the pressure chamber. The air pressure can be read from the pressure gauge to monitor the air pressure in the pressure chamber and to adjust when necessary to maintain a most desirable air pressure in the pressure chamber.

### BACKGROUND OF THE INVENTION

1. Field of the Invention

This invention relates to a shock absorber having a pressure gauge, and more particularly to a pressure gauge mounted on the top of a pressure chamber to detect the pressure in the pressure chamber and do the necessary adjustment.

2. Description of the Prior Art

As shown in FIG. 3, a conventional shock absorber for a bicycle comprises a main body A with a hydraulic rod A1 extending outward from the main body A. The hydraulic rod A1 and the main body A are surrounded by a spring A2. One end of the main body A is connected to a pressure chamber A3 having a piston A4 therein. Hydraulic oil A5 is poured into one end of the pressure chamber A3 to operate the hydraulic rod A1. The other end of the pressure chamber A3 is formed with an air inlet A6 to input air into the pressure chamber A3 to push the piston A4.

The conventional shock absorber used on a bicycle is mostly set to a certain level, which is safe but not comfortable to the rider. The modern air tank for pumping air into the shock absorber is to connect its nozzle to the air inlet A6 of the pressure chamber A3 to pump air A7. During the process, the pressure gauge indicates air in the pressure chamber A3. When air in the pressure chamber A3 is full, the user pulls the nozzle away from the air inlet A6. Some air will leak, and the pressure in the pressure chamber A3 is changed from what it measured. The pressure in the pressure chamber A3 will also drop after a period of time. In order to measure the volume of air in the pressure chamber A3, the user has to reconnect the pressure gauge to get measurement.

### SUMMARY OF THE INVENTION

It is the primary objective of the present invention to provide a shock absorber having a pressure gauge, which has a pressure gauge mounted on the top of a pressure chamber to read easily and to adjust pressure when necessary.

It is another objective of the present invention to provide a shock absorber having a pressure gauge, which provides an easy way to acquire pressure measurement, so as to add or release pressure in the pressure chamber.

### BRIEF DESCRIPTION OF THE DRAWINGS

FIG. 1 is a side view of the present invention;

FIG. 2 is a side view showing that air is pumped into a pressure chamber; and

FIG. 3 is a side view of a prior art.

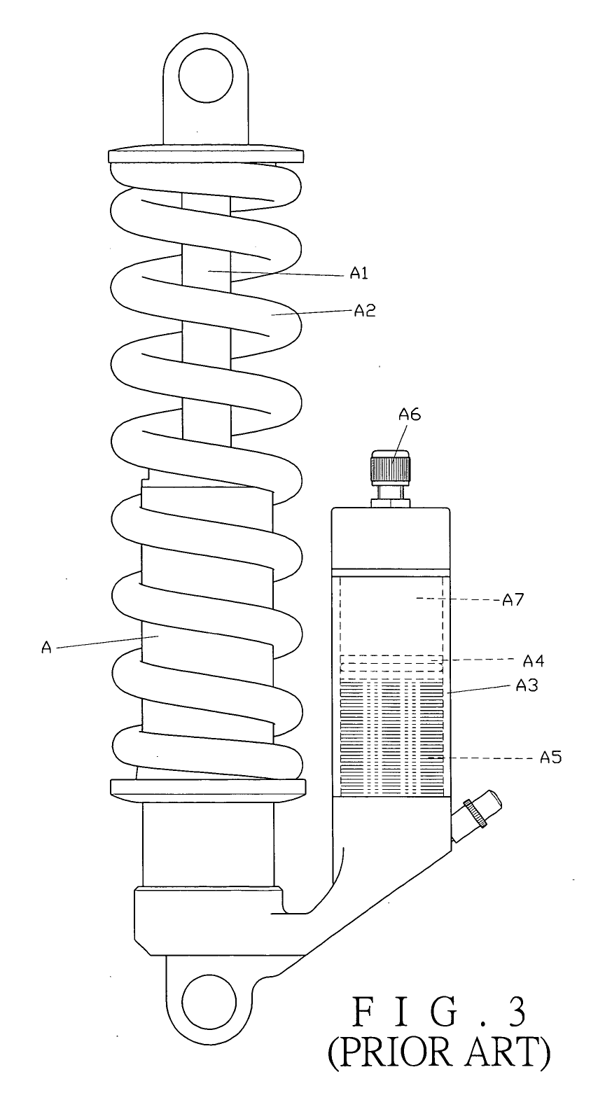

### DETAILED DESCRIPTION OF THE PREFERRED EMBODIMENT

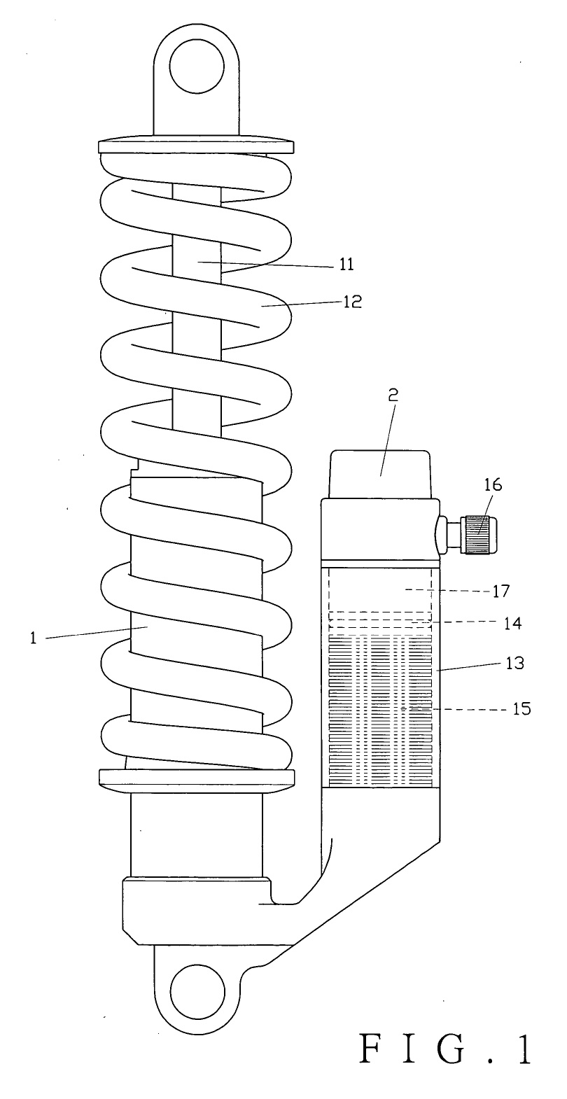

The present invention comprises a main body 1 and a pressure gauge 2, as shown in FIG. 1.

The main body 1 comprises a hydraulic rod 11 extending from inward of the main body 1. The main body 1 and the hydraulic rod 11 are surrounded by a spring 12. A pressure chamber 13 is provided at one side of the main body 1 with a piston 14 therein. Hydraulic oil 15 is poured into one end of the pressure chamber 13 to operate the hydraulic rod 11 to extend from the main body 1. The pressure chamber 13 at one side is provided with an air inlet 16 to pump air into the pressure chamber 13 so as to drive the piston 14.

The pressure gauge 2 is mounted on the top of the pressure chamber 13 and interconnected with the pressure chamber 13 to measure pressure in the pressure chamber 13.

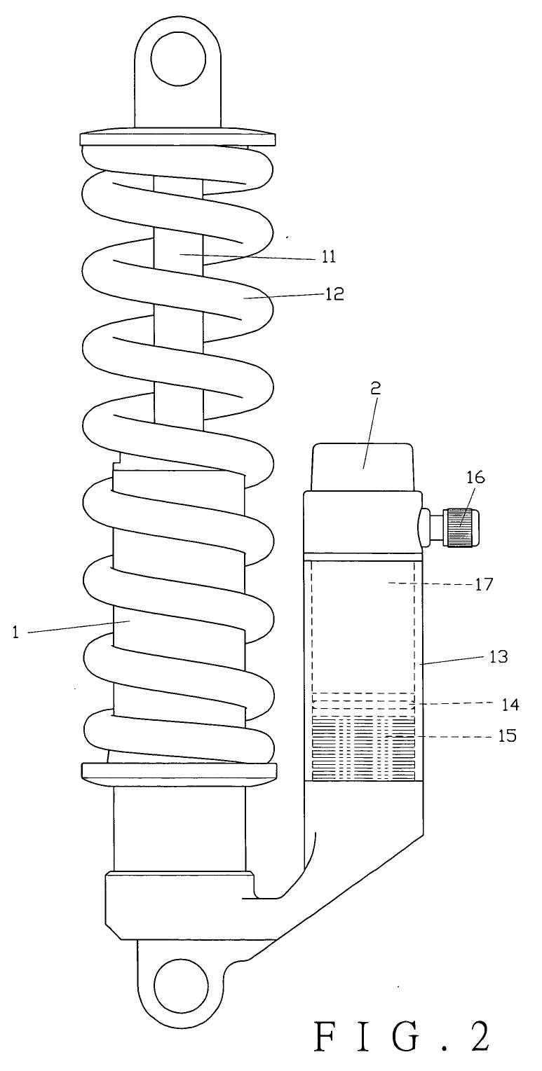

To operate the present invention, as shown in FIG. 2, the air inlet 16 is connected to the nozzle of an air pump to pump air 17 into the pressure chamber 13 and drive the piston 14. The piston 14 then drives the hydraulic oil 15 to urge the pressure rod 11 to extend outward from the main body 1. The air pressure can be read from the pressure gauge 2 to monitor air in the pressure chamber 13 and to adjust when necessary to maintain a most desirable air pressure in the pressure chamber 13.

What is claimed is:

1. A shock absorber having a pressure gauge comprising:
a main body comprising a hydraulic rod extending therefrom, said main body and said hydraulic rod being surrounded with a spring, said main body being connected at one end with a pressure chamber having a piston therein, one end of said pressure chamber being filled with hydraulic oil, said pressure chamber comprising an air inlet at one side to pump air into said pressure chamber; and characterized in that:
said pressure chamber comprising a pressure gauge mounted on top of said pressure chamber, said pressure gauge being interconnected with said pressure chamber to measure air pressure in said pressure chamber.
